(19) United States
(12) Patent Application Publication
(10) Pub. No.: US 2006/0255913 A1
(43) Pub. Date: Nov. 16, 2006

(54) Security up

(76) Inventor: Kazutora Yoshino, Eden Prairie, MN (US)

Correspondence Address: Kazutora Yoshino, 7227 Divinity Ln., Eden Prairie, MN, 55346, US

(21) Appl. No.: 11/126,803

(22) Filed: May 12, 2005

(51) Int. Cl. G05B 19/00

(52) U.S. Cl. 340/5.81; 340/5.51

(57) ABSTRACT

The invention of Yoshino security system makes our security much better than how it has been. Security-mouse is shown having personal signal controlling device as example. The invention of Yoshino security system is consist of communication system means comprising group components comprising recognizing system, identifying system, input system, output system and operation system.

### FEDERALLY SPONSORED RESEARCH

Not Applicable

### SEQUENCE LISTING OR PROGRAM

CROSS REFERENCE TO RELATED APPICATIONS of Doc. Number, KYU001E001, and Y15A001 by Kazutora Yoshino and Emily Yoshino

### BACKGROUND OF THE INVENTION

1. Field of invention

People dreamed of righteous relationship.

We still miss the righteous relationship.

2. Description of the Prior Art

Patent Application with Doc. Number KYU001E001 of Kazutora Yoshino as inventor shows the Yoshino systems.

Pub. App. No. 20030222977, by Kazutora Yoshino, shows the algorithm and system of pattern recognition. This is good for identification analysis, yet need application.

### SUMMARY OF THE INVENTION

Applicant thinks that the missing of righteous relationship is highly co-related to missing of security such as personal security.

The invention of Yoshino security system makes our security much better than how it has been.

For convenience, the following combinations may be considered as not easy to connect for the effects of inventions though the spirit of invention is not limited to the components shown. K) is for component, E) is for effect, and R) is for reason, as abbreviation in this specification, claim, and abstract. Numbers are added as subscription.

The invention of Yoshino security system is consist of communication system means comprising group components comprising
K0) communicator means such as communicator(s), user(s), person, people, system(s), software(s), hardware(s), memory(s), hard drive(s), central processing unit(s), multiple processing unit(s), operator(s), operating system(s), manufacture(s),
E0) to be for the system/security to be needed and/or protected,
R0) because of the desire and feeling that communicator means like to be needed and/or protected,
K1) Time efficient system means such as system/programming/algorithm of secure system combined with yoshino system, security system on line, security system on operating system, security system on internet, security system,
E1) To be for time efficient means such as to be time efficient, much more instant, faster, and faster more,
R1) because of the fact by nature of yoshino system to be faster, and security,
K2) Convenient system means such as hand and/or finger identification system in mouse and/or key board, finger identification system in wheel in mouse, hand pattern reading, finger print identification system, hand blood stream pattern reading system in mouse, continuous and/or discontinuous reading of such patterns, signal/information readers in device(s) attached to computer(s), electromagnetic wave readers in device(s) attached to computer(s), infrared signal readers in mouse(s), infrared signal reader in wireless mouse, infrared signal reader in infrared signal mouse, hand sign/ signal reader with optical mouse, optical mouse that can read bar code, QR code(s), and/or three dimensional QR code(s) as Doc. Num. Y15A001 of Kazutora & Emily Yoshino, as codes for higher security and/or privacy, mouse that can read bar code(s), QR code(s), and/or three dimensional QR code(s) with camera(s), mouse with display(s) and/or camera (/video camera), mouse with three dimensional pattern scanner and three dimensional display(s), mouse(s) with input(s), output(s) and operator(s), mouse with credit card scanner, keyboard with credit card scanner, hand-writing recognition system, hand-writing recognition system with touch panel and/or by mouse hand-writing,
E2-1) To be for convenient means such as to be much more convenient, much more often usable, more convenient in logging in, more convenient while using/holding it,
R2-1) because of the fact that most of operating system uses mouse/keyboard now days that holding of mouse is natural actions,
E2-2) To be for cost effective, without too much of extra costs for the personal usage,
R2-2) because of the space available in mouse/key board and the signal reader such as (infrared) signal reading device matches so properly that attachment of signal reading device is simply done in manufacturing process,
E2-3) To be for communicator means not getting to be annoyed,
R2-3) because communicator means has no extra work to have identification check, for system user(s), system(s) and program(s),
E2-4) To be for having much more secured system without too much system load,
R2-4) because pattern recognition program is made by applicant, which has very little loads for system, as in patent application of applicant system,
E2-5) To be for secured transactions/transportation of proper entity such as trans-money means such as money, points, proper information such as properly created ideas and information to be protected.
R2-5-1) because it connects with identification system which control trans-money, with secured fire wall(s) in system of trans money means that transact, transport, hold, save, add interests to, input, output, and/or operate trans-money in internet,
R2-5-2) because it has infrared/wave reader, for the convenience of software and hardware, it is convenient to create the system, which is difficult to read from long distance communication by somebody else,
K3) More convenient system means such as face recognition system, voice recognition system, motion recognition system, brain wave reading system, brain wave communicating system, hand motion reading system, hand signal/pattern reading system, living signal/pattern reading system means such as living signal/pattern reading system, infrared signal pattern reader, biological information communicator, biological wave reading device in multiple dimensions, system to identify communicator means by signal detector(s) and/or by position and/or motion detector(s), eye pattern checker(s), and such systems in computer and/or device(s) attached to computer(s),
E3-1) To be for being much more convenient without touching/tangent to communicator means,

E3-2) To be for much higher security without users paying attentions,
K4) Influential system means such as security on line, system on line, data base on line, security in government, broad casting system,
E4-1) To be for being more influential, for security of system,
E4-2) To be for secured transactions/transportation of proper entity such as money, points, proper information such as properly created ideas and information to be protected.
K5) Bio checker means such as Blood checker(s), genetic checker(s), DNA checker(s), RNA checker(s), SNP checker(s), hair (genetic) checker(s), mitochondrion checker(s), mitochondrion DNA and/or RNA checker(s), protein checker(s), checker(s)
E5) To be for accuracy, of the system, for higher or better identification,
K6) Communication system with choices of communicator means such as character(s), choice(s), character(s) that make communicator means to be happy, favoring character(s), option(s), option that have communicator means to be able to choose, option that have communicator means to be able to choose character(s), choice of with communicator means letting communicator means know that what kind of communication it/they is/are taking such as what risks to said communicator means so that communicator(s) may pay less attentions due to such communication alternatively (while undergoing of calculation of identification if it is need not to be shown/expressed to communicator means if it is ok with communicator means and if it is not deceptive to communicator means),
E6-1) To be for communicator means letting not know/knowing too much how their identification has been checked by identification system and still protected.
E6-2) To be for being happy.

### OBJECTIVE AND ADVANTAGE OF INVENTIONS

The goal of this invention is to make person/personal identification for communicator means such as personal user(s), system(s) users and system(s) to be much more effective means comprising group components of
1) To be much more instant and faster,
2) To be much more convenient,
3) To be much more effective, for identification means,
4) To be with more influence, for security of system,
5) To be with accuracy, of the system, for higher or better identification,
6) To be with cost effective, without too much of extra costs for the personal usage,
7) To be with much higher security without users paying attentions,
8) To be without users getting to be annoyed,
9) To be much more secured system without too much system load,
10) To be for secured transactions/transportation of proper entity such as money, points, proper information such as properly created ideas and information to be protected,
11) To be for without letting communicator means know/knowing too much how their identification has been checked by identification system and still protected.
12) And To be happy.

### BRIEF DESCRIPTION OF DRAWINGS

FIG. 1 is the diagram of identification system in mouse.

### DETAIL DESCRIPTION OF DRAWING

Mouse means such as optical, wave, infrared, electromagnetic wave operate-able mouse is shown. It can read, emit and operate the signal(s). favoring character(s), option(s), option that have communicator means to be able to choose, option that have communicator means to be able to choose character(s), choice of with communicator means letting communicator means know that what kind of communication it/they is/are taking such as what risks to said communicator means so that communicator(s) may pay less attentions due to such communication alternatively (while undergoing of calculation of identification if it is need not to be shown/expressed to communicator means if it is ok with communicator means and if it is not deceptive to communicator means),
E6-1) To be for communicator means letting not know/knowing too much how their identification has been checked by identification system and still protected.
E6-2) To be for being happy.

### OBJECTIVE AND ADVANTAGE OF INVENTIONS

The goal of this invention is to make person/personal identification for communicator means such as personal user(s), system(s) users and system(s) to be much more effective means comprising group components of
1) To be much more instant and faster,
2) To be much more convenient,
3) To be much more effective, for identification means,
4) To be with more influence, for security of system,
5) To be with accuracy, of the system, for higher or better identification,
6) To be with cost effective, without too much of extra costs for the personal usage,
7) To be with much higher security without users paying attentions,
8) To be without users getting to be annoyed,
9) To be much more secured system without too much system load,
10) To be for secured transactions/transportation of proper entity such as money, points, proper information such as properly created ideas and information to be protected,
11) To be for without letting communicator means know/knowing too much how their identification has been checked by identification system and still protected.
12) And To be happy.

### BRIEF DESCRIPTION OF DRAWING

FIG. 1 is the diagram of identification system in mouse.

### DETAIL DESCRIPTION OF DRAWING

Mouse means such as optical, wave, infrared, electromagnetic wave operate-able mouse is shown. It can read, emit and operate the signal(s).

1. The invention of yoshino security system that secures system or combinations of systems.

2. The invention of yoshino security system is consist of communication systems for comprising
communicator means such as communicator, user, person, people, system, software, hardware, memory, hard drive, central processing unit, multiple processing unit, operator, operating system, manufacture,
Time efficient system means such as system, programming and algorithm of secure system combined with yoshino system, security system on line, security system on operating system, security system on internet, security system,
Convenient system means such as hand and/or finger identification system in mouse and/or key board, finger identification system in wheel in mouse, hand pattern reading, finger print identification system, hand blood stream pattern reading system in mouse, continuous or discrete reading of said patterns such as signal and information readers in device attached to computer, electromagnetic wave readers in device attached to computer, infrared signal readers in mouse, infrared signal reader in wireless mouse, infrared signal reader in infrared signal mouse, hand signal reader with optical mouse, optical mouse that reads code means such as bar code, quality reading code, and three dimensional quality reading code, mouse that reads bar code, quality reading code, and three dimensional quality code with camera, mouse with display and camera means such as camera and video camera, mouse with three dimensional pattern scanner and three dimensional display, mouse with input, output and operator,
More convenient system means such as face recognition system, voice recognition system, motion recognition system, brain wave reading system, brain wave communicating system, hand motion reading system, hand writing recognition system, hand signal pattern reading system, living signal pattern reading system means such as living signal pattern reading system, infrared signal pattern reader, biological information communicator, biological wave reading device in multiple dimensions, system to identify communicator means by signal detector means such as position and motion detector, eye pattern checker, and such systems in computer and/or device attached to computer, mouse with credit card scanner, keyboard with credit card scanner, hand-writing recognition system, hand-writing recognition system with touch panel and/or by mouse hand-writing,
Influential system means such as security on line, system on line, data base on line, security in government, broad casting system,
Bio checker means such as blood checker, genetic checker means such as, checker, nucleic acid, deoxyribonucleic-acid checker, ribonucleic-acid checker, nucleic processing checker, hair checker, mitochondrion checker, mitochondrion checker, protein checker, checker
Communication system with choices of communicator means such as character, choice, character that make communicator means to be happy, favoring character, option, option that have communicator means to be able to choose, option that have communicator means to be able to choose character, choice of with communicator means letting communicator means know that what kind of communication it/they is/are taking such as what risks to said communicator means so that communicator may pay less attentions due to such communication alternatively

3. In the claim of 1, 2 wherein said yoshino security system comprising plurality of said yoshino security system.
